(19) United States
(12) Patent Application Publication
(10) Pub. No.: US 2022/0358384 A1
(43) Pub. Date: Nov. 10, 2022

(54) DOMAIN TRANSFERRABLE FACT VERIFICATION SYSTEMS AND METHODS

(71) Applicant: Arizona Board of Regents on Behalf of the University of Arizona, Tucson, AZ (US)

(72) Inventors: Mithun Paul, Tucson, AZ (US); Mihai Surdeanu, Tucson, AZ (US); Sandeep Suntwal, Tucson, AZ (US); Rebecca Sharp, Tucson, AZ (US)

(21) Appl. No.: 17/736,683

(22) Filed: May 4, 2022

Related U.S. Application Data
(60) Provisional application No. 63/184,284, filed on May 5, 2021.

(51) Int. Cl. G06N 5/04; G06N 5/02; G06N 3/08; G06N 3/04

(52) U.S. Cl. CPC G06N 5/045; G06N 5/022; G06N 3/08; G06N 3/0427

(57) ABSTRACT

A domain fact verification system is described having a computer programmed with a model trained using a process of data distillation and model distillation to improve model learning of the underlying semantics of a dataset rather than relying on statistical and lexical nuances in a domain-specific dataset. The computer thus programmed can accurately perform fact verification across multiple domains without the labor-intensive process of encoding a dataset of human-annotated, domain-specific information for each domain. Moreover, by combining data distillation with model distillation techniques, which may be seen as an inverse of well-established ensemble strategies (which train individual models separately and applies them jointly) the present domain transferable fact verification system scales better at inference time due to its reliance on a single trained model.

### CROSS-REFERENCE TO RELATED APPLICATIONS

This application claims the benefit of the filing date and disclosure of U.S. Provisional Patent Application No. 63/184,284, filed on May 5, 2021, the content of which is incorporated herein by reference in its entirety.

### BACKGROUND OF THE INVENTION

### Field of the Invention

The invention relates to automated fact verification, or so-called “fact checking,” of online published statements. More specifically, the invention relates to devices and systems programmed for the automated machine processing of online claims to determine, within a given level of confidence, the truthfulness or correctness of the claims.

### Description of Related Art

Fact verification is the task of verifying the truthfulness of claims by estimating their assertions against credible evidence. As a technique, fact verification has emerged as a critical task with important societal implications.

Formally, fact verification is defined as: given a pair of claim and evidence texts, determine if the evidence supports (agrees), rejects (disagrees), or is unable to classify (neutral) the claim (a neutral classification would be the result of not enough information in the claim or the evidence to reach a specific classification conclusion), with a prescribed level of confidence (i.e., how confident is one's conclusion that a claim is “true” or “false” from their review of available relevant evidence).

The use cases for fact verification are many. In one instance, a social media entity may employ fact verification to assess the veracity of posts made by customers on the entity's social media platform (i.e., whether the claim or assertion in the claim is “fake news”). An educational entity may wish to use fact verification for educational purposes. A media entity may use fact verification to assess sources of information before relying on the sources for a story. Individuals may use fact verification to preview draft statements before publishing them online. And, governmental agencies and law enforcement entities may use fact verification in the course of performing their duties.

Manual fact-checking is, of course, labor intensive and thus is not scalable to a level needed by entities that require a response to published claims at machine speed. Automated fact-checking systems have thus been developed to replace manual processes. Automated systems use devices with programs that embody algorithms reflecting various combinations of techniques, such as those for retrieving documents (e.g., posts) from multiple open sources in a relevant domain that could support or contradict a domain-specific claim, detecting the viewpoint or perspective of a document's author(s) with regard to the specific claim (i.e., a particular author's “stance”), identifying a degree of trustworthiness of the source of the retrieved documents, and verifying the claim based on the viewpoint or perspective of the author(s) and the trustworthiness of the source. The output of such systems might be a label for the claim, such as “agree,” “disagree,” or “neutral.”

Machine fact verification employs deep learning, including the use of neural networks that have achieved state-of-the-art performance across many natural language processing (NLP) tasks. However, neural networks may not generalize well due to overfitting on statistical and lexical nuances (or artifacts) specific to a particular dataset. Thus, while a specific neural network model may work well for a particular dataset in one domain, it may not transfer well across other domains involving other kinds of data.

To overcome this problem using currently available neural networks, others have simply trained a neural network and created a model using a dataset that is specific to the domain of interest. For example, a chosen model architecture could be trained using a corpus of language texts that might be topically classified as “political” to create a model that is useful for assessing political claims, and the same model architecture (or a different architecture) could be separately trained on a corpus of language texts that might be topically classified as “scientific” to create a separate model that is useful for assessing scientific claims, etc.

Others have used ensemble learning, a process of constructing a system in which different learning models or techniques are employed to find the best or an optimal model or approach for classification tasks for a particular domain or other domains. A classifier ensemble, for example, may include a weighted combination of a first classifier and a second classifier that have been iteratively learned from one or more datasets.

Training a neural network using multiple domain-specific datasets, however, is a labor-intensive process because it requires a human subject matter expert to classify each and every assertion as either true or false, and it is computationally expensive because of the repeated training required to create multiple models. Similarly, ensemble learning may also be resource intensive due to the need to explore multiple different machine learning and other techniques.

What is needed, therefore, are devices, systems, and methods for performing automated fact verification that do not require separate, fully trained, domain-specific models or the use of ensemble approaches. Specifically, there is a need for a computer that has been programmed for improved automated domain transferable fact verification.

### BRIEF SUMMARY OF THE INVENTION

Described herein are exemplary devices, systems, and methods for a domain transferable fact verification system that overcomes the problem of having to train multiple domain-specific models. Specifically, described herein are exemplary devices, systems, and methods that include a computer having a program stored therein containing at least one learning model that is accurate across more than one domain. The learning model is developed by combining data distillation with model distillation techniques as described herein to reduce the risk of over delexicalization.

In one embodiment, the domain transferable fact verification system includes a stored program having a model based on a teacher-student architecture. The student model is trained on delexicalized data (to take advantage of data distillation) but is also guided by a teacher trained on the original lexicalized data (as a form of model distillation) to mitigate the possibility of discarding too much lexical information present in data.

An advantage of the domain transferable fact verification system as presently described is that, a computer, programmed with a model that combines a process of data distillation with model distillation to improve model learning, is better able to encode the true underlying semantics of a dataset rather relying on the statistical and lexical nuances in a domain-specific dataset, and thus is able to accurately performs fact verification across multiple domains. That eliminates the need to perform the labor-intensive process of encoding a dataset of human-annotated, domain-specific information. Moreover, by combining data distillation with model distillation techniques, which may be seen as an inverse of well-established ensemble strategies (which train individual models separately and applies them jointly) the present fact verification system scales better at inference time due to its reliance on a single model at that point of the process.

It was discovered that a program having a learning model developed by the present technique could achieve a cross domain accuracy of 73.29% when the model was trained using the FEVER dataset and then tested using the FNC dataset, and could achieve a cross domain accuracy of 74.46% in the other direction, outperforming other stand-alone trained methods that rely on lexicalized data. Thus, a computer programmed with that learning model would be expected to perform better than existing computers using other fact verification models.

In one exemplary configuration, a fact verification system containing the learning model described herein may be implemented in the cloud on one or more data servers that receive and parse incoming application programming interface (API) payloads containing one or more claims for fact verification. The cloud-based system could return a specific classification or label based on the highest confidence (e.g., probability) identified from among various possible classifications or labels. Users or customers could be charged a fee based on, for example, each API request they submit.

Other aspects, objects, advantages, and features of the invention may become hereinafter apparent. The nature of the invention may be more clearly understood by reference to the following detailed description of the invention, the appended claims, and to the several drawings attached herein.

### BRIEF DESCRIPTION OF THE DRAWINGS

FIG. 1 is a schematic diagram of a model architecture for improving the ability of trained NLP models to work across domains;

FIG. 2 is a schematic diagram of a model architecture for further improving the ability of trained NLP models to work across domains; and

FIG. 3 is a schematic diagram of an exemplary implementation of a domain transferable fact verification system.

### DETAILED DESCRIPTION OF THE INVENTION

Several preferred embodiments of the invention are described for illustrative purposes, it being understood that the invention may be embodied in other forms not specifically shown in the drawings.

The drawing figures herein are provided for exemplary purposes and are not drawn to scale. Specific details are described to provide an understanding of the inventive concepts; however, one of ordinary skill in the art will understand that the inventive concepts described here may be practiced without these specific details. In other instances, well-known features have been omitted or only briefly mentioned to avoid unnecessarily complicating the description.

The term “or” used here generally refers to an inclusive or and not an exclusive or. For example, a condition or list A or B is satisfied by any one of the following: A is true (or present) and B is false (or not present), A is false (or not present) and B is true (or present), and both A and B are true (or present). The term “a” or “an” are generally employed to describe elements and components of the embodiments herein for convenience of the reader and to give a general sense of the inventive concepts, and may be understood to include one, or at least one, the singular, and the plurality unless it is obvious that another meaning was intended.

A reference to “embodiments,” “implementations,” “configurations,” or “constructs” may refer to a particular element, feature, structure, or characteristic of the invention but does not mean the reference is to a single or the same embodiment or implementation. It is to be understood that the present invention may be implemented in various forms. For example, the invention may be embodied in hardware, software, firmware, special purpose computing devices, or a combination thereof centrally located or distributed, and operated or controlled by one person or entity or multiple people or entities. Throughout this description, the term “user” may be a person engaging with the system.

The invention may be implemented in software as a program tangibly embodied on a computer readable storage medium device. A computer readable storage medium may be any tangible medium that can contain a program that an instruction execution machine, apparatus, or device may “read” for the purpose of executing the instructions contained in the program. The program may be uploaded to, and executed by, the instruction execution machine comprising any suitable architecture, either centrally executed or executed on distributed devices networked to each other. Preferably, the machine executing the program is implemented on a computer having hardware including one or more central processing units (CPU); one or more memory devices, such as a random access memory (RAM); and one or more input/output (I/O) interface devices, such as peripheral device interfaces. The computer may also include an operating system and microinstruction code. The various processes and functions described herein may either be part of the microinstruction code or part of the program (or combination thereof) which is executed via the operating system. In addition, various other peripheral devices may be connected or networked to the computer such as additional data storage and printing devices, and various sensors, including biological, environmental, and/or other sensors for authenticating users, as needed.

It is to be further understood that, because some of the constituent system components and method steps depicted in the accompanying figures are preferably implemented in software, the actual connections between the system components (or the process steps) may differ depending upon the manner in which the present invention is programmed.

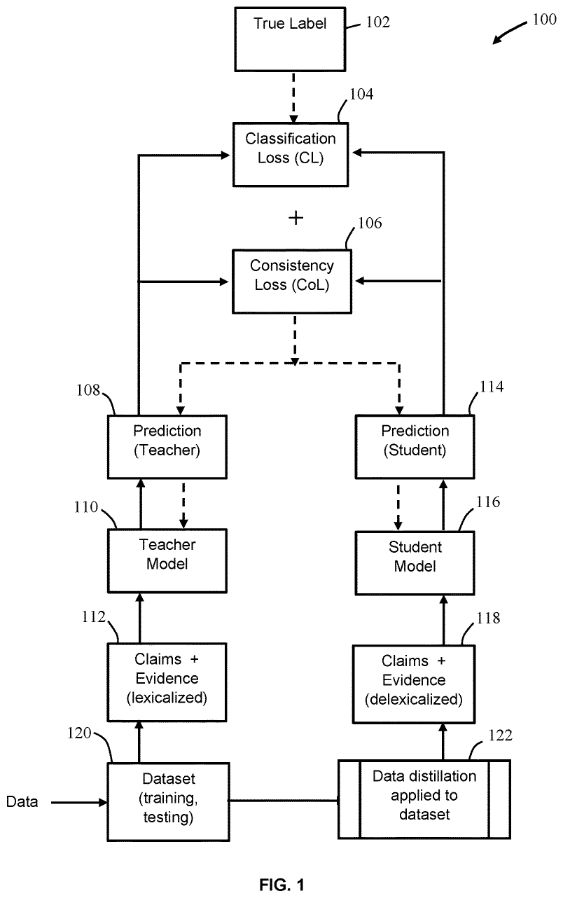

Turning first to FIG. 1, shown therein is a schematic diagram of a model architecture for improving the ability of trained NLP models to work across domains, which is further described in “Data and Model Distillation as a Solution for Domain-transferable Fact Verification” (in Proceedings of the 2021 Conference of the North American Chapter of the Association for Computational Linguistics: Human Language Technologies), the content of which is incorporated by reference herein. The model architecture shown consists of two separate deep learning models: a “teacher” model 110 and a “student” model 116, which are separately but synchronously trained by inputting specific data as claims and evidence (text with embeddings) 112, 118 from a dataset 120 (or from multiple datasets, in other embodiments).

The output of the models 110, 116, consisting of, respectively, prediction labels 108, 114 (i.e., “agree” or “disagree”), are compared to a true label 102 to assess a classification loss 104 (“CL”); and compared to each other to assess a consistency loss 106 (“CoL”). The combined losses are passed back down to the models 110, 116 using known techniques in the art (e.g., back propagation) to update the hyperparameters of the models 110, 116 (e.g., the individual node weights of the neural networks). Each subsequent inputted claims and evidence information from the dataset 120 is sequentially processed in the same way and the subsequent losses are used to further adjust the hyperparameters until the losses are minimized and the models 110, 116 are considered fully trained. Once trained, the student model 116 may be deployed in the wild as part of a software stored on a computer storage media for subsequent fact verification purposes (the teacher model 110 could also be deployed, as needed).

The teacher model 110 and the student model 116 may include, for example, a recurrent neural network (RNN), a bi-direction transformer network, or some other network architecture. In one implementation, the Mini BERT transformer model may be employed (Turc et al. 2019), which is a light-weight version of the BERT transformer architecture, to input claims and evidence and output the prediction labels 108, 114 of the teacher and student models 110, 116, respectively. In one embodiment, two different fact verification datasets, FEVER and FNC, could be used as the dataset 120 for training and testing purposes, respectively.

In the approach shown in FIG. 1, the true underlying semantics of a dataset 120 may be learned rather than allowing a model to rely on the statistical and lexical nuances in a domain-specific dataset. That is, to mitigate the dependency on specific artifacts in a dataset that might limit the performance of the student model 116 across multiple domains, a predefined data distillation (or delexicalization) process 122 is used, which replaces some lexical artifacts such as named entities with their type and a unique identifier to indicate occurrence of the same artifact in a claim (C) and in its corresponding evidence (E).

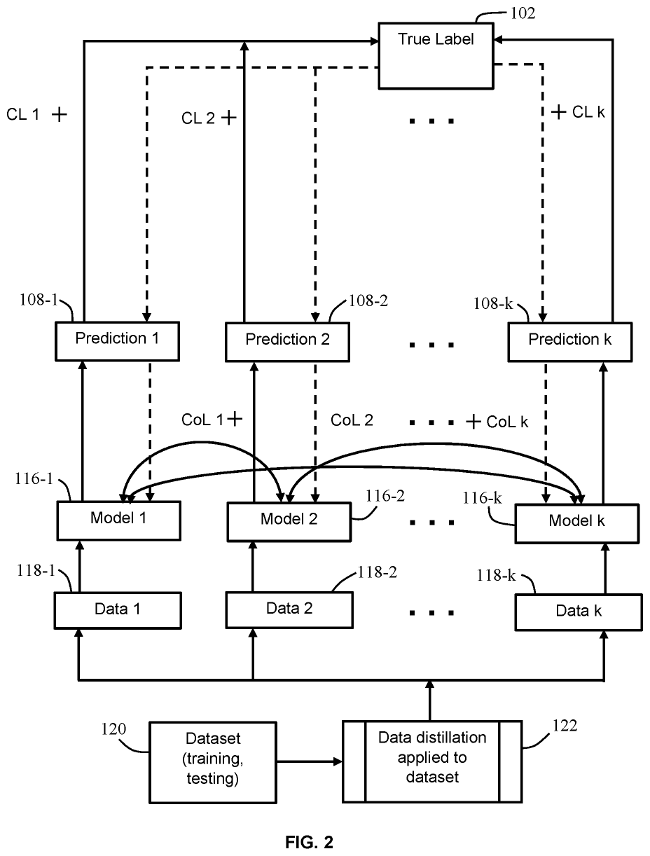

In particular, one or more named entity recognizer functions (as described below with regard to FIG. 2) may be used in the predefined data distillation (or delexicalization) process 122 to detect and replace named entities present in a text with their most specific or a generalized label returned by one of the named entity recognizer functions. Named entities in both claims and evidence are aligned. For instance, any named entity that appears first in a claim is assigned an identifier postfixed with #Cn; if an entity mention appears only in evidence then it is postfixed with #En, where C indicates that the entity appeared first in the claim, E indicates that the entity first appeared in the evidence, and n indicates the nth observed entity. Table 1 shows an example output from the predefined data distillation process 122 applied to a data record in the dataset 120:

TABLE 1

| | Claim (C) | Evidence (E) |
|---|---|---|
| Plain text | Mark Zuckerberg made the Forbes | In December 2016, Zuckerberg was |
| (named | list of The World's Most Powerful | ranked 10th on Forbes list of The World's |
| entity | People | Most Powerful People. |
| recognizer | | |
| input) | | |
| Distilled | personC1 made the Forbes list of | In December 2016, personC1 was ranked |
| text | written_workC1's Most Powerful | 10^{th} on Forbes list of written_workC1's |
| (named | People. | Most Powerful People. |
| entity | | |
| recognizer | | |
| output) | | |

The intuition behind the teacher-student approach is that the teacher model 110 “pulls” the student model 116 toward the original underlying semantics of the text that is inputted, which are partially obscured to the student model 116 due to the delexicalization of its training data after the predetermined data distillation process 122 is performed. More formally, this approach captures some of the underlying semantics through the consistency loss that minimizes the difference in the predicted label 108, 114 distributions between the student model 116 and the teacher model 110, respectively. The consistency loss may be implemented as a mean squared error between the predicted labels 108, 114 predicted by the teach and the student models 110, 116, respectively.

Additionally, both the student and the teacher components may include a regular classification loss on their respective data, which may be implemented using techniques known in the art, such as by using a cross entropy loss function. Together with the consistency loss, this approach (using the consistency loss and the classification loss together) encourages both the student model 116 and the teacher model 108 to learn as much as possible from their own views of the data in the dataset 120 used for training.

It is recognized, however, that this approach may discard too much information through the delexicalization process. For example, replacing China with its named entity type (COUNTRY) in an evidence sentence discards the fact that the text is about an Asian country, which might be relevant contextual information useful in assessing a specific claim or evidence. In that case, another construct of the model could be used.

Specifically, FIG. 2 show a schematic diagram of a model architecture for further improving the ability of trained NLP models to work across domains, which is described in “Students Who Study Together Learn Better: On the Importance of Collective Knowledge Distillation for Domain Transfer in Fact Verification” (in Proceedings of the 2021 Conference on Empirical Methods in Natural Language Processing), the content of which is incorporated by reference herein. In the configuration shown in FIG. 2, the student model 116 of FIG. 1 may be replaced with multiple student models 116-1, 116-2, . . . , 116-k (i.e., “Model 1,” “Model 2,” . . . , “Model k”), each of which has access to a different delexicalized view of the dataset data as inputting claims and evidence 118-1, 118-2, . . . , 118-k, respectively (as in the previous configuration of FIG. 1, two different fact verification datasets, FEVER and FNC, could be used as the dataset 120 for training and testing purposes, respectively).

The multi-student model approach shown in FIG. 2 encourages each student model 116-1, 116-2, . . . , 116-k, to learn from the others student models through the pair-wise consistency losses as illustrated in FIG. 2. For example, the student model 116-1 and the student model 116-2 may be updated using consistency loss CoL1 of the student model 116-1 and the consistency loss CoL2 of the student model 116-2.

Once training is complete for each of the student models 116-1, 116-2, . . . , 116-k, the student model 116-1, 116-2, . . . , 116-k with the best performance (i.e., highest accuracy with respect to a comparison between the individual predictions 114-1, 114-2, . . . , 114-k compared to the true label 102) is kept for evaluation purposes (testing) and/or the selected model may be deployed in the wild as part of a software stored on a computer for subsequent fact verification purposes. Note that by selecting and using the best performing student model, the evaluation run time cost is the same as for a single classifier model; that is, there is no added computational cost.

In the approach reflected in FIG. 2, the student models 116-1, 116-2, . . . , 116-k each use multiple named entity recognizer functions as part of the predefined data distillation (or delexicalization) process 122 for detecting and replacing the named entities with varying levels of granularity. For example, the student model 116-1 may use the Overlap Aware named entity recognizer (OA-NER); the student model 116-2 may use the FIGER Abstract named entity recognizer, which replaces the named entity with the most abstract classes returned by the FIGER named entity recognizer (e.g., LOCATION for Los Angeles); and the student model 116-k may use the FIGER Specific named entity recognizer, which uses the most specific classes returned by the FIGER named entity recognizer (e.g., CITY for Los Angeles). Table 2 shows example outputs from the predefined data distillation process 122 applied to a data record in the dataset 120 using various named entity recognizers, which illustrates the various degrees of specificity or generality of the resulting named entities:

TABLE 2

| | Claim | Evidence |
|---|---|---|
| Plain text | J. R. R. | A dwarf warrior, he is the son of Glóin-LRB-a character from |
| (input) | Tolkien | Tolkien's earlier novel, The Hobbit-RRB-. Gimli is a fictional |
| | created | character from J. R. R. Tolkien's Middle-earth legendarium, |
| | Gimli. | featured in The Lord of the Rings. |
| OA-NER | personC1 | A dwarf warrior, he is the son of personE1-LRB-a character from |
| (output) | created | personC1's earlier novel, The Hobbit-RRB-. personC2 is a |
| | personC2. | fictional character from personC1's locationE1 legendarium, |
| | | featured in The Lord of the Rings. |
| FIGER | authorC1 | A dwarf warrior, he is the son of personE1-LRB-a character from |
| Specific | created | authorE1's earlier novel, The Hobbit-RRB-. locationC1 is a |
| (output) | locationC1. | fictional character from authorC1's written workE1 legendarium, |
| | | featured in The Lord of the Rings. |
| FIGER | personC1 | A dwarf warrior, he is the son of personE1-LRB-a character from |
| Abstract | created | personC1's earlier novel, The Hobbit-RRB-. locationC1 is a |
| (output) | locationC1 | fictional character from personC1's written workE1 legendarium, |
| | | featured in The Lord of the Rings. |

In the group learning architecture of FIG. 2, each student model 116-1, 116-2, . . . , 116-k is trained on two different versions of the same dataset, each delexicalized differently by using different data distillation techniques as shown in Table 2 and using the distributions of predictions of the other models. This combined methodology of knowledge distillation encourages each of the student models 116-1, 116-2, . . . , 116-k to learn as much as possible from their own views of the data while jointly learning with the benefit of the other student models. Training together on the soft labels (distribution of predictions) of other student models acts as a form of regularization between all student models. More formally, each student model 116-1, 116-2, . . . , 116-k includes a regular classification loss (implemented, for example, using the cross-entropy function) on their respective data. Additionally, each student model 116-1, 116-2, . . . , 116-k has a consistency loss between all other models that minimizes the difference in predicted label distributions between them.

The intuition behind the group learning approach described above is that, by providing multiple data distillation options to choose from, the student models 116-1, 116-2, . . . , 116-k are encouraged to “pull” towards each other and the original underlying semantics. The part of semantic knowledge that is obscured from a student model (due to the particular delexicalization technique used in the dataset version it sees) is instead learned in its effort to perform on par with other models. Thus, like a classroom environment where the students learn from both known labels (e.g., a textbook) and by helping another student learn, each student is able to thus choose the right amount of granularity needed to enhance its own understanding.

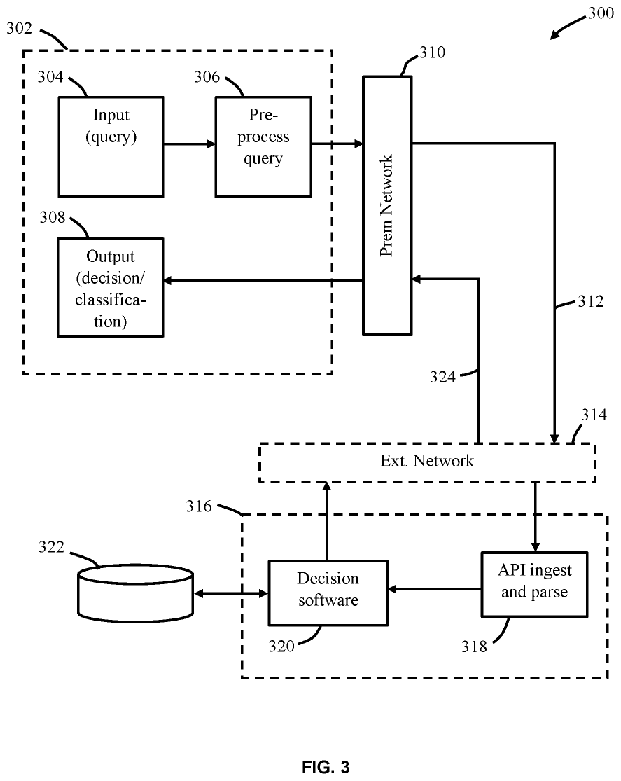

Turning now to FIG. 3, shown therein is a schematic diagram of a domain transferable fact verification system 300 having one or more input/output devices 302, one or more on-site/on-premise networks 310, an external network 314, one or more computers 316, and one or more data storage devices 322. (For clarity, only one of each device or components of the fact verification system 300 is shown).

The input/output device(s) 302 may be, for example, digital computing devices such as a laptop computer, a desktop computer, a rack server computer, a smartphone, a tablet, or any other electronic computing device that a user may use to access the fact verification system 300. In some embodiments, the input/output device(s) 302 may be considered “front end” or “client” devices.

The on-site/on-premise network(s) 310 may be, for example, enterprise local area networks or combinations of different but interconnected local area networks, which is/are used to facilitate the communication of data between the components of the fact verification system 300.

The external network 314 may be, for example, the Internet, which may be used to facilitate the communication of data to and from the on-site/on-premises network 310.

The computer(s) 316 may be, for example, one or more local “back end” servers or remote cloud-based servers that have been appropriately instantiated with a fully-trained decision model as described above for the run-time processing of manually-entered or automated fact verification queries.

The data storage device(s) 322 may be, for example, electronic data storage devices with data stored therein that is organized in one or more data structures such as a relational database.

The domain transferable fact verification system 300 may be deployed and used as follows. First, a user may use one of the input/output devices 302 to manually enter a query 304 for fact verification (by extrapolation, multiple different users could each use respective different input/output devices 302 to manually enter their own specific query 304 for fact verification).

Each input query may be processed, as needed, using a preprocessor module 306 according to a particular application programming interface (API) protocol scheme and then sent individually as an API payload request 312 via the on-site/on-premises network 310 and the external network 314 to one of the computers 316. At the computers 316, the API requests 312 may be parsed using an API ingest/parser module 318 to extract the specific user query encoded in the payload request 312. The query may then be input into the decision software 320, which makes a classification decision (e.g., agree/disagree/neutral, true/false/unknown, etc.) and outputs a signal 324 containing the classification decision (i.e., label). The decision software 320 may include, for example, an instantiation of the fully trained model described above with respect to FIG. 1 or FIG. 2. The decision software 320 may be stored in a suitable data storage medium (e.g., memory) and processed using one or more suitable processors (e.g., graphical or tensor processing units).

The output signal 324 from the decision software 320 may be received by the output device 308 (e.g., a display) and presented to the user in some useful form (e.g., text or graphical indicia).

One of ordinary skill will appreciate that the computers 308, including the API ingest/parser module 318 and the decision software 320, may be implemented locally and/or in the cloud, and/or on a single device, such as the input/output devices 302. That is, the fully trained model may be stored locally to provide fact verification without requiring connection to a cloud-based computer. Moreover, the API ingest/parser module 318 may be replaced with any other protocol or technique for facilitating the transfer of queries and data to the decision software 320.

In another aspect, a user may initiate a process that automatically inputs one or more fact verification queries 304 by, for example, receiving queries from multiple other users, and/or populating a list (or lists) of open sources where one or more documents, posts, statements, and other information may be downloaded or scrapped to identify possible queries. For example, the multiple users could be separate customers who wish to process their own claims from one or more documents, posts, statements, and other information for fact verification and who provide information to be fact verified. As the fact verification system 300 receives these customer's inputs (queries), synchronously or asynchronously, a first input query 304 may be identified. The first query 304 may be processed as needed using, as described above, the preprocessor module 306 according to the particular API protocol scheme used by the fact verification system 300, and then sent as the API payload request 312 via the on-site/on-premises network 310 and the external network 314 to one of the computers 316 of the fact verification system 300. The API payload request 312 associated with the first input query 304 may be parsed using the API ingest/parser module 318 to extract the specific customer's query that is encoded in the payload request 312. The query may be input into the decision software 320 of the kind described above, which then makes a classification decision (e.g., agree/disagree/neutral, true/false/unknown, etc.) and outputs a signal 324 containing the classification. The output signal 324 may be received by the output device 308 (e.g., a display) and presented to the customer. This process is repeated for a second input query 304 that is identified from the one or more documents, posts, statements, and other information of the same customer or from a different customer until all of the claims identified in the corpus of documents, posts, statements, and other information and all queries from all customers have been fact verified.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. For example, which the fact verification system is described using textual data, the system could also process image data to verify claims about the image. Accordingly, it is intended that the invention be limited only to the extent required by the appended claims and the applicable rules of law.

We claim:

1. A system for automatically performing fact verification across at least two domains comprising:
a computer for receiving an input having one or more claims; and
a media-stored, processor-executed software having instructions for automatically:
processing the one or more claims as input to a decision model;
causing the decision model to verify the inputted one or more claims by using the one or more claims and evidence related to the one or more claims, wherein the process of verifying includes outputting by the decision model a label for each of the one or more claims selected from a set of classification labels; and
returning the label output for each of the one or more claims to an output device;
wherein the decision model comprises a student model that is synchronously trained with a teacher model, wherein the teacher model is trained using a training dataset in which none of the data in the training dataset has been delexicalized, and wherein the student model is trained using the training dataset in which at least some of the data in the training dataset has been at least partially delexicalized, and wherein during training each of the teacher and the student models is iteratively updated using a classification loss and a consistency loss computed at the time of each of the iterations until the training process is complete.

2. The system of claim 1, wherein the decision model comprises a student model selected from a plurality of student models, wherein each of the plurality of student models is trained using the data in the training dataset that has been at least partially and differently delexicalized for each of the plurality of student models, and wherein during training each of the teacher and the plurality of student models is iteratively updated using pair-wise combinations of the classification losses and the consistency losses of at least two of the models computed at the time of each of the iterations until the training process is complete.

3. The system of claim 1, wherein the at least partially delexicalized data comprises data in which named entity terms in the data have been replaced with different new terms.

4. The system of claim 1, wherein the student model comprises at least a transformer architecture component and a neural network architecture component for processing the one or more claims and the evidence related to the one or more claims.

5. The system of claim 1, wherein the consistency loss is calculated at each of the iterations as a difference between a classification by the student model and a classification by the teacher model.

6. The system of claim 5, wherein the classification loss is calculated at each of the iterations as a difference between the classification by the student model compared to an actual or true classification, and a classification by the teacher model compared to the actual or true classification.

7. A method for automatically performing fact verification across at least two domains comprising:
receiving an input having one or more claims;
processing the one or more claims as input to a decision model;
causing the decision model to verify the inputted one or more claims by using the one or more claims and evidence related to the one or more claims, wherein the process of verifying includes outputting by the decision model a label for each of the one or more claims selected from a set of classification labels; and
returning the label output for each of the one or more claims to an output device,
wherein the decision model comprises a student model that is synchronously trained with a teacher model, wherein the teacher model is trained using a training dataset in which none of the data in the training dataset has been delexicalized, and wherein the student model is trained using the training dataset in which at least some of the data in the training dataset has been partially delexicalized, and wherein during training each of the teacher and the student models is iteratively updated using a classification loss and a consistency loss computed at the time of each of the iterations until the training process is complete.

8. The method of claim 7, wherein the decision model comprises a student model selected from a plurality of student models, wherein each of the plurality of student models is trained using the data in the training dataset that has been at least partially and differently delexicalized for each of the plurality of student models, and wherein during training each of the teacher and the plurality of student models is iteratively updated using pair-wise combinations of the classification losses and the consistency losses of at least two of the models computed at the time of each of the iterations until the training process is complete.

9. The method of claim 7, wherein the at least partially delexicalized data comprises data in which named entity terms in the data have been replaced with different new terms.

10. The method of claim 7, wherein the student model comprises at least a transformer architecture component and a neural network architecture component for processing the one or more claims and the evidence related to the one or more claims.

11. The method of claim 7, further comprising calculating the consistency loss at each of the iterations as a difference between a classification by the student model and a classification by the teacher model.

12. The method of claim 11, further comprising calculating the classification loss at each of the iterations as a difference between the classification by the student model compared to an actual or true classification, and a classification by the teacher model compared to the actual or true classification.

13. The method of claim 7, wherein the process of delexicalizing the data in each of the different at least partially delexicalized datasets comprises using a different named entity recognizer to identify and replace the named entities in the data with different identifiers having different levels of specificity or generality.
